(19) United States
(12) Patent Application Publication
(10) Pub. No.: US 2007/0068916 A1
(43) Pub. Date: Mar. 29, 2007

(54) HEATING BLANKET COVER CONSTRUCTION AND METHODS OF MANUFACTURE

(76) Inventors: Scott D. Augustine, Bloomington, MN (US); Randall C. Arnold, Minnetonka, MN (US); Rudolf A. Deibel, Eden Prairie, MN (US); Scott A. Entenman, St. Paul, MN (US); Keith J. Leland, Medina, MN (US); Thomas F. Neils, Minneapolis, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 11/537,134

(22) Filed: Sep. 29, 2006

Related U.S. Application Data
(60) Provisional application No. 60/722,243, filed on Sep. 29, 2005.
(60) Provisional application No. 60/722,242, filed on Sep. 29, 2005.

(51) Int. Cl. H05B 3/00

(52) U.S. Cl. 219/212

(57) ABSTRACT

A heating blanket cover is constructed from a lower sheet, which may include a first material layer laminated to a second material layer, and an upper sheet bonded to the lower sheet along a longitudinally extending bonding site, wherein the upper sheet extends laterally from the bonding site over the lower sheet to a free edge. The bonding site may be formed by heat sealing the upper sheet to the lower sheet. A gap between the upper sheet and the lower sheet forms an enclosure to hold the heating blanket; the enclosure is accessible by lifting the free edge of the upper sheet away from the lower sheet. A series of covers may be formed, for example by a web-manufacturing process, by bringing together at least two lengths of materials, bonding the lengths together and assembling the lengths on a roll for dispensing of individual covers from the series.

### PRIORITY CLAIM AND RELATED APPLICATION

The present application claims priority to co-pending Provisional Application Ser. No. 60/722,243, having the same title, and to co-pending Provisional Application Ser. No. 60/722,242 entitled COVER FOR A HEATING BLANKET, both of which are hereby incorporated by reference in their entireties. The present application is related to the commonly assigned utility application entitled, COVER FOR A HEATING BLANKET, filed concurrently herewith and incorporated by reference, in its entirety, herein.

### TECHNICAL FIELD

The present invention pertains to flexible covers for heating units, for example, electric blankets, and more particularly to construction and manufacturing methods for such covers.

### BACKGROUND

For over a decade, forced-air warming (FAW), via an inflatable air blanket, has been used in operating rooms to prevent hypothermia in surgical patients. It is well established that surgical patients under anesthesia become poikilothermic. This means that the patients lose their ability to control their body temperature and will take on or lose heat depending on the temperature of the environment. Since modern operating rooms are all air conditioned to a relatively low temperature for surgeon comfort, the majority of patients undergoing general anesthesia will lose heat and become clinically hypothermic, if not warmed. FAW has become the “standard of care” for preventing and treating the hypothermia caused by anesthesia and surgery. FAW consists of a large heater/blower attached by a hose to an inflatable air blanket. The warm air is distributed over the patient within the chambers of the blanket and then is exhausted onto the patient through holes in the bottom surface of the blanket. Although FAW is clinically effective, it suffers from several problems including: a relatively high price; air blowing in the operating room, which can be noisy and can potentially contaminate the surgical field; and the inflatable blanket is relatively bulky over the patient, at times even obscuring the view of the surgeon. Moreover, the low specific heat of air and the rapid loss of heat from air requires that the temperature of the air, as it leaves the hose, be dangerously high—in some products as high as 45° C. This creates significant dangers for the patient. Second and third degree burns have occurred both because of contact between the hose and the patient's skin, and by blowing hot air directly from the hose onto the skin, without connecting a blanket to the hose. This condition is common enough to have its own name—“hosing.” The manufacturers of forced air warming equipment actively warn their users against hosing and the risks it poses to the patient.

The logistics of forced-air warming and the bulk of the inflatable air blankets have motivated the development of electric or warm water circulating heating blankets. Many of these heating blankets are reusable so that the blankets must either be cleaned between uses, or the blankets must be enclosed in a clean cover for each use. Inadequate cleaning can cause cross contamination between patients. Cleaning is not only time consuming during the rapid turnover of the operating room after each case, but the labor for the cleaning is also expensive.

There is a need for heating blanket covers that are easily manipulated for placing a heating blanket therein and do not compromise the comfort of a person about which the blanket is placed. Since it is desirable that heating blanket covers be disposable, there is a need for cost-effective constructions, manufacturing methods and dispensing methods for such covers.

### SUMMARY

Certain embodiments of the present invention pertain to the construction of covers for flexible heating blankets. According to certain embodiments of the present invention, these covers include an upper flexible sheet, which is bonded to a lower flexible sheet, and an enclosure, which is disposed between the upper and lower sheets, for holding a flexible heating blanket; the enclosure includes one or more edges defined by one or more bonding sites of the upper sheet to the lower sheet. The upper sheet includes a panel, not adhered to, or being separable from, the lower flexible sheet, to provide an opening for the enclosure; the panel extends from a bonding site, or a first edge of the enclosure, to a free edge of the upper sheet. After folding back the panel to open the enclosure, a heating blanket may be laid down upon the lower sheet where it may be secured within the enclosure by closing the panel thereover; the panel may include a reversible fastening element to help secure the heating blanket within the enclosure.

Some cover embodiments include an upper flexible sheet that has a first panel and a second panel, each of the first and second panels not adhered to, or being separable from the lower flexible sheet, to provide the opening for the heating blanket enclosure. The first and second panels, according to these embodiments, when closed, extend toward one another from opposite edges of the enclosure, which may be defined by bonding sites of the upper flexible sheet to the lower flexible sheet, and may be opened by folding back in opposite directions. When closed, the first panel may overlap the second panel and one or both of the panels may include one or more reversible fastening elements to help secure the heating blanket within the enclosure beneath the panels. The fastening elements may be any one of a number of types known to those skilled in the art, for example hook and loop, snap-fit, button, tie strip, and adhesive (low or high tack) types.

Preferably, a lower flexible sheet of the cover has characteristics providing efficient heat transfer between the heating blanket enclosure of the cover and a person disposed beneath the lower sheet of the cover, while an upper flexible sheet of the cover has characteristics providing insulation and blood and fluid protection between the heating blanket enclosure and the area above the upper sheet. The lower flexible sheet of the cover may further provide a relatively soft interface for the person beneath the cover.

According to some embodiments of the present invention, the lower flexible sheet includes a first or bottom layer forming an outer surface of the cover and a second or top layer forming an inner surface of the heating blanket enclosure; the first layer, being formed of a fibrous material, woven or non-woven, is laminated with the second layer, which is formed of a polymeric material. Suitable laminating means include, but are not limited to, adhesive bonding, heat bonding and extrusion coating. Examples of suitable fibrous materials include, but are not limited to, polyester, polypropylene, nylon, rayon and cellulose, i.e. from wood pulp fibers; and examples of suitable materials for the second layer include, but are not limited to, polyethylene, polypropylene, polyolefin, ethylvinylacetate (EVA) and polyurethane. The upper sheet is formed of a polymer film or of a laminated material, similar to the lower sheet; according to preferred embodiments a heat sealing method is used to bond the upper sheet to the lower flexible sheet so that one or more bonding sites form a border for the enclosure, and a panel of the upper sheet is left non-adhered to the lower flexible sheet to form an opening for the enclosure. According to this preferred embodiment, the fibrous material of the first layer of the lower sheet has a melting point higher than that of either of the polymer of the second layer of the lower sheet or the polymer film forming the upper sheet.

According to some manufacturing methods of the present invention, a first length of laminated material, which includes a first layer of a fibrous material and a second layer of a polymeric material, is brought together with a second length of material, which may be a polymer film, or which may include first and second layers, similar to the first length of laminated material; if the second length is laminated, like the first length, the second and first lengths would be brought together so that the polymeric layers are adjacent one another. Preferably, a web-type manufacturing process is used to bring the two lengths of materials together, to bond the lengths together, and then to assemble the bonded lengths into a roll for the dispensing of individual covers. The process may further include a perforating step to segregate lengthwise segments of the length, each segment to form an individual cover, and thus increase the ease of dispensing.

According to some preferred embodiments of the present invention, bonding results in at least one lengthwise extending bond site formed between the first an second lengths, and bonding is accomplished via a heat sealing method, examples of which include, but are not limited to, thermal sealing, impulse sealing or dielectric or radio frequency sealing. A portion of the second length of material, which extends laterally from the at least one bond site over the first length, is left un-adhered to the first length such that a gap exists between the two lengths in order to form an enclosure being accessible via the portion of the second length which forms at least one panel.

According to a one-panel embodiment, the un-adhered portion extends laterally from the bonding site to a free edge of the second length of material. According to a two panel embodiment, approximately parallel bonds are formed on either side of the un-adhered portion and a slit is formed dividing the un-adhered portion into two panels that open away from one another. A slitting process may occur in line with the bonding process, either previously, simultaneously or subsequently, or may occur in a secondary operation after bonding. According to an alternate two-panel embodiment, a third length of material, along with the second length, is brought together with the first length of material and bonded thereto along a bonding site approximately parallel to the bonding site of the first length; an un-adhered portion of the third length extends laterally from the bonding site thereof, toward the un-adhered portion of the second length, to a free edge thereof, and, in some cases, overlaps the second length.

Fastening elements may be pre-formed, or attached, to one or all of first, second and third lengths of material. Alternately, for any of the embodiments, fastening elements may be formed on, or attached to, panels after the bonding process.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIGS. 1A-B are top and end views, respectively, of a heating blanket cover, according to some embodiments of the present invention.

FIGS. 2A-B are top and end views, respectively, of the blanket cover of FIGS. 1A-B enveloping a heating blanket.

FIGS. 3A-B are top and end views, respectively, of a heating blanket cover, according to some alternate embodiments of the present invention.

FIGS. 4A-B are top and end views, respectively, of the blanket cover of FIGS. 3A-B enveloping a heating blanket.

FIGS. 5A-C are sections illustrating a bonding detail between a laminated lower flexible sheet and an upper flexible sheet, according to preferred embodiments of the present invention.

FIG. 6A is a side view of a schematic rendering of a portion of a web-type manufacturing line, according to some embodiments of the present invention.

FIG. 6B is an end view of a portion of the manufacturing line shown in FIG. 6A, according to some embodiments of the present invention.

FIG. 6C is an end view of the portion of the manufacturing line shown in FIG. 6A, according to some alternate embodiments of the present invention.

FIG. 6D is an end view of the portion of the manufacturing line shown in FIG. 6A, according to yet further embodiments of the present invention.

FIG. 6E is a perspective view of a roll of covers, according to some embodiments of the present invention.

### DETAILED DESCRIPTION

The following detailed description is exemplary in nature and is not intended to limit the scope, applicability, or configuration of the invention in any way. Rather, the following description provides practical illustrations for implementing exemplary embodiments of the present invention. Examples of constructions, materials, dimensions, and manufacturing processes are provided for selected elements, and all other elements employ that which is known to those of skill in the field of the invention. Those skilled in the art will recognize that many of the examples provided have suitable alternatives that can be utilized.

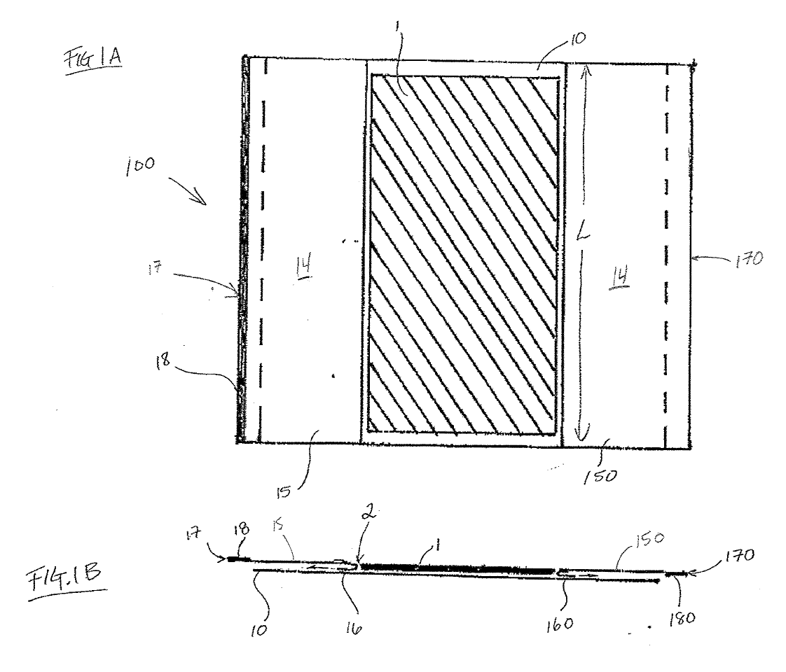

FIGS. 1A-B are a top view and an end view of a heating blanket cover 100 according to some embodiments of the present invention. FIGS. 1A-B illustrate cover 100 including a lower flexible sheet 10 to which an upper flexible sheet 14 is bonded, in which upper flexible sheet 14 includes a first panel 15 and a second panel 150; bonding sites 16 and 160 of upper flexible sheet 14 may extend along a length L of panels 15, 150. Although bonding sites 16, 160 are illustrated having a generally narrow width, in alternate embodiments upper sheet 14 may extend further laterally over lower sheet 10, according to the arrows in FIG. 1B, being bonded along that extent. First and second panels 15, 150 extend from bonding sites 16, 160, respectively to a first free edge 17 (panel 15) of the upper sheet and a second free edge 170 (panel 160) of the upper sheet, and are illustrated folded back away from one another.

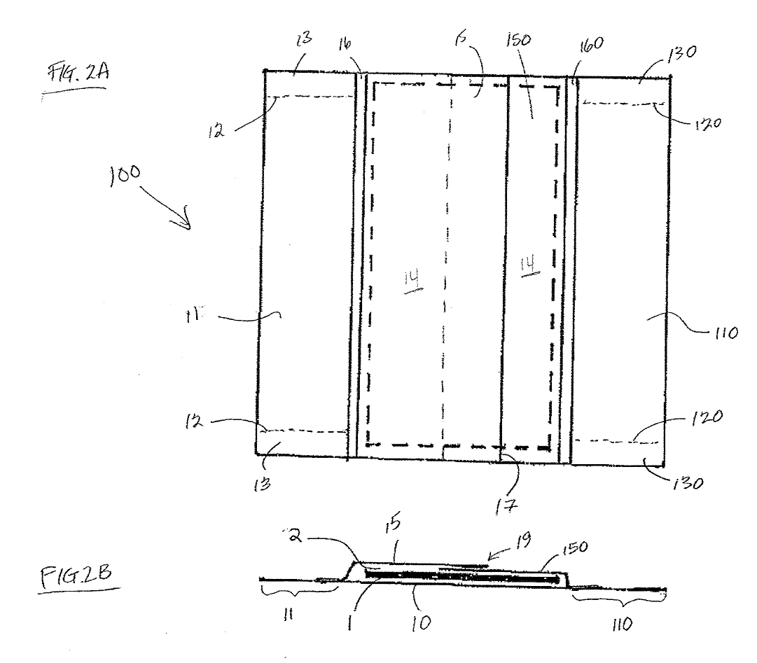

FIGS. 1A-B further illustrate a reusable heating blanket 1 disposed upon lower flexible sheet 10 within an enclosure 2 between bonding sites 16, 160. According to certain embodiments of the present invention, enclosure 2 is easily accessible by folding back panels 15, 150 of the upper sheet, as illustrated. FIGS. 2A-B are a top and end view of cover 100 wherein panels 15, 150 are closed over heating blanket 1; according to the illustrated embodiment, an overlap junction 19 of panels 15, 150 helps to secure heating blanket 1 within enclosure 2. According to some embodiments of the present invention, one or both of panels 15, 150 include one or more reversible fastening elements disposed in proximity to respective edges 17, 170; FIGS. 1A-B illustrate an embodiment wherein mating strips of fastening material 18 and 180, for example hook and loop type or adhesive type, extend along panel edges 17 and 170, respectively. FIGS. 2A-B further illustrate cover 100 including lateral portions or flaps 11 and 110 extending laterally beyond enclosure 2; according to certain embodiments of the present invention flaps 11, 110 are useful for holding heating blanket 1 in place over a patient, for example by tucking flaps 11, 110 around sides of the patient.

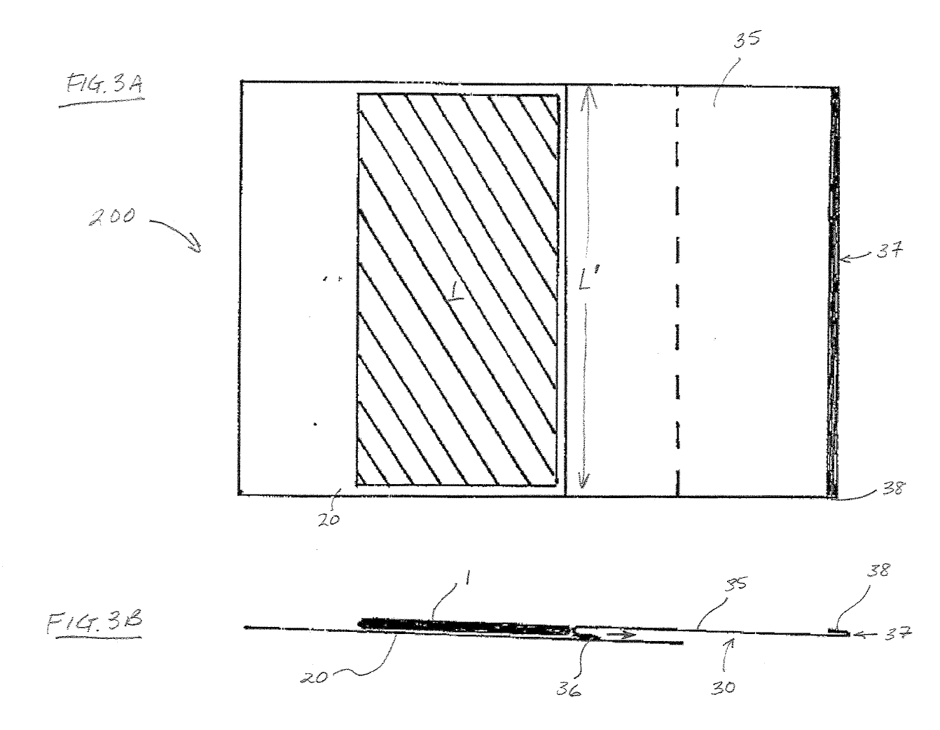

FIGS. 3A-B are a top view and an end view of a cover 200 according to alternate embodiments of the present invention. FIG. 3A illustrates cover 200 including a lower flexible sheet 20 to which an upper flexible sheet 30 is bonded; a panel 35 of upper flexible sheet 30, shown folded away from lower flexible sheet 20, extends from a bonding site 36 to a free edge 37 of sheet 30. Bonding site 36 may extend along a length L′ of panel 35 and, although bonding site 36 is illustrated having a relatively narrow width, site 36 may extend further laterally over lower sheet 20 according to the arrow in FIG. 3B.

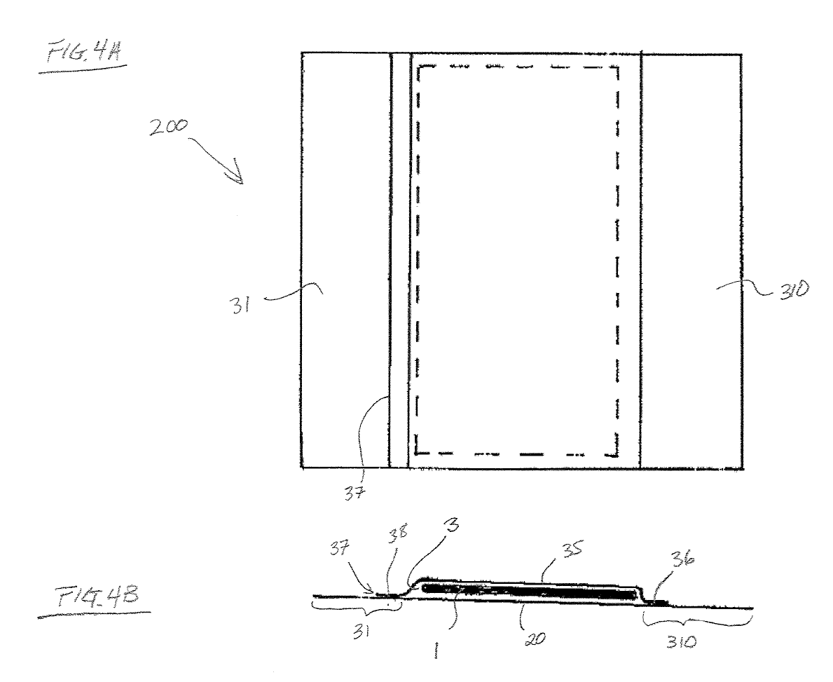

FIGS. 4A-B further illustrate heating blanket 1 disposed upon lower flexible sheet 20 adjacent bonding site 36 which forms an edge of an enclosure 3 when panel 35 is closed over blanket 1, as illustrated in FIGS. 4A-B. From FIGS. 3A-B and 4A-B, the ease with which blanket 1 may be placed in enclosure 3, by first folding back panel 35 and then closing panel 35 over blanket 1, may be appreciated. Panel 35 may be reversibly fastened to lower sheet 20 in order to secure blanket 1 within enclosure 3; and FIGS. 3A-B illustrate a preferred embodiment in which a strip of fastening material 38, for example an adhesive strip, extends along length L′ of panel 35 in proximity to free edge 37. FIGS. 4A-B illustrate strip 38 of panel 35 adhered to lower flexible sheet 20 to secure blanket 1 within enclosure 3. According to alternate embodiments, lower sheet 20 and panel 35 include mating fastening elements, examples of which include, but are not limited to, hook and loop type, button type and snap-fit type.

FIGS. 4A-B further illustrate flaps 31 and 310 extending laterally beyond either side of enclosure 3. Similar to flaps 11, 110 of cover 100, flaps 31, 310 extend laterally over a sufficient length so that flaps 31, 310 may be tucked around sides of a patient on a bed or an operating table.

Preferably, a material or materials selected for upper flexible sheet 14 of cover 100 and upper flexible sheet 30 of cover 200 provides some thermal insulation, and potentially also protection against fluids, between heating blanket 1 and an area outside enclosures 2, 3, on an opposite side of upper sheet 14, 30, while a material or materials selected for lower flexible sheets 10, 20 allows efficient heat transfer therethrough between heating blanket 1 and patient disposed on an opposite side of lower sheets 10, 20. It is also preferable that lower flexible sheets 10, 20 of covers 100, 200 have sufficient flexibility to drape over and conform with contours of a patient, and, furthermore, include a relatively soft lower surface to make a comfortable interface with the patient.

According to certain embodiments of the present invention, lower flexible sheets 10, 20 are laminated and include a first layer of fibrous material, woven or non-woven, laminated with a layer of polymeric material. Examples of suitable fibrous materials include, but are not limited to, polyester, polypropylene, nylon, rayon and cellulose, i.e. from wood pulp fibers; and examples of suitable polymeric materials for the laminated layer include, but are not limited to, polyethylene, polypropylene, polyolefin, ethylvinylacetate (EVA) and polyurethane. Suitable laminating means include, but are not limited to, adhesive bonding, heat bonding and extrusion coating. The polymeric material layer of a laminated lower flexible sheet forms an upper surface on which heating blanket 1 would be laid, and to which an upper flexible sheet is bonded. The upper flexible sheet may be formed of a single layer of polymer film, or may also be laminated, including a layer of fibrous material overlaid with a polymeric material. The upper sheet is bonded to the lower flexible sheet, preferably, by a heat sealing method, for example thermal sealing, impulse sealing or dielectric or radio frequency sealing. According to this preferred embodiment, the fibrous layer of the lower flexible sheet has a melting point higher than the polymeric top layer of the lower sheet; and, likewise for the upper flexible sheet, if laminated, the fibrous layer having a higher melting point than the polymer overlay.

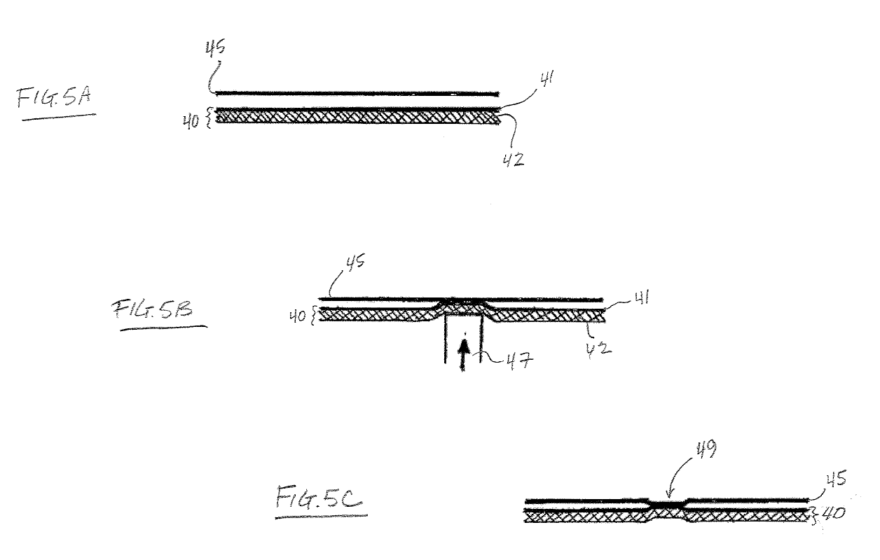

FIGS. 5A-5C are sections illustrating bonding detail between a laminated lower flexible sheet 40 and an upper flexible sheet 45, according to some embodiments of the present invention. FIG. 5A shows lower flexible sheet 40 including a lower layer 42 formed of a fibrous material and an upper layer 41 formed of a polymeric material; upper flexible sheet 45, formed of a polymeric film, is positioned adjacent polymeric layer 41 of lower flexible sheet 40 for bonding. FIG. 5B shows a heat sealing tool 47 being pressed against fibrous layer 42 of lower sheet 40, per the arrow, to urge polymeric layer 41 against upper flexible sheet 45 as heat energy is delivered through tool 47 to bond polymeric layer 41 to polymeric sheet 45; according to the illustrated embodiment, the energy passes through layer 42 without melting layer 42 so that tool 47 may easily slide along and/or pull away from lower layer 42. The upper sheet 45 is preferably supported by a rubber roller, but may also be supported by other material supports or by tensions pulling sheet 45 taut, or by air pressure. FIG. 5C illustrates a resultant bond 49 between upper sheet 45 and lower sheet 40. According to an exemplary embodiment of the present invention, a lower sheet, for example, lower sheet 40, has a thickness ranging from approximately 0.5 oz/yd² (17 g/m²) to 3 oz/yd² (100 g/m²) and is either comprised of a Spunbond polypropylene, which is extrusion coated, or laminated, with low density polyethylene, or a Spunbond/meltblown/Spunbond polypropylene, which is extrusion coated, or laminated, with polyolefin film; and an upper sheet, for example, upper sheet 45, has a thickness ranging from approximately 0.0005 in (0.0125 mm) to approximately 0.004 in (0.102 mm), and is either comprised of a low density polyethylene (LDPE) or a LDPE/ethylvinylacetate (EVA) blend.

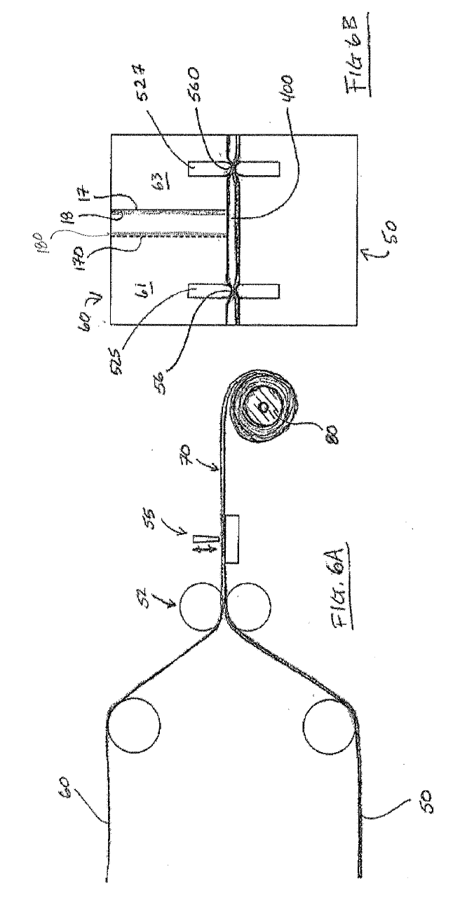

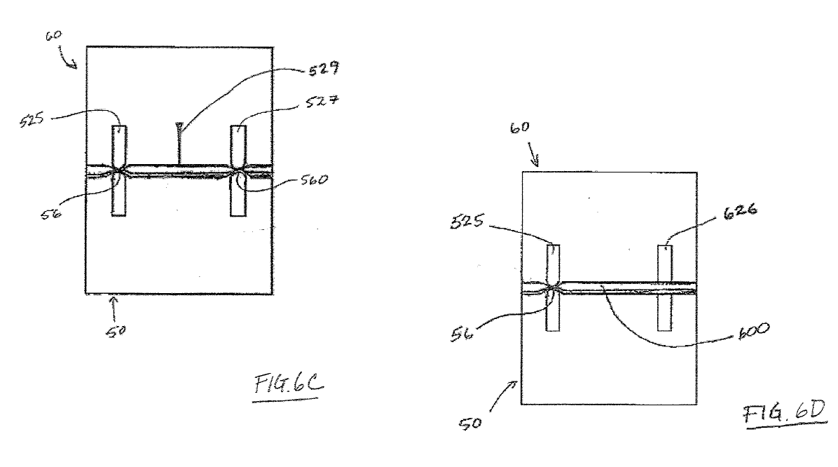

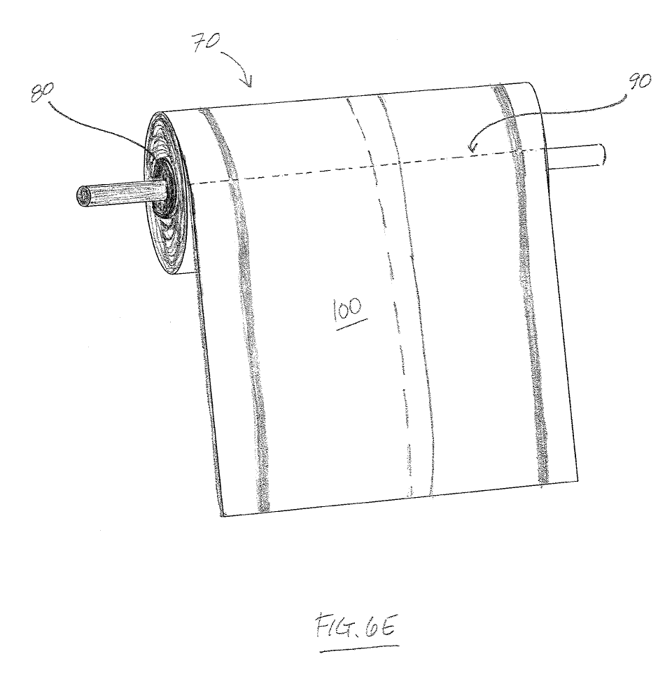

FIG. 6A is a side view of a schematic rendering of a portion of a web-type manufacturing line according to some embodiments of the present invention. FIG. 6A illustrates the manufacturing line bringing together, at mechanism 52, a first length of laminated material 50 with a second length of material 60; first length 50 corresponds to a series of lower flexible sheets including a fibrous layer overlaid with a polymer film, and second length 60 corresponds to a series of upper flexible sheets being formed of a polymer film. First length of laminated material 50 is oriented such that the polymer film overlay is facing second length of material 60.

FIG. 6B, an end view of a portion of the manufacturing line shown in FIG. 6A, illustrates mechanism 52 including a first pair of heat sealing rollers 525 spaced apart from a second pair of heat sealing rollers 527. According to the illustrated embodiment, as lengths of material 50, 60 are fed through mechanism 52, rollers 525, 527 form lengthwise parallel bonds 56 and 560 that couple first length of material 50 to second length of material 60 and leave an un-adhered portion in between designated by a gap 400.

Heat sealing parameters for the exemplary embodiments of lower and upper sheets as described above are as follows: a temperature ranging from approximately 200° C. to approximately 1400° C.; a sealing speed ranging from approximately 50 feet/minute to approximately 200 feet/minute; and a sealing pressure ranging from approximately 50 to approximately 200 lb/linear inch of web width.

FIG. 6B further illustrates second length of material 60 including a first portion 61 extending alongside and overlapping a second portion 63. Referring back to FIGS. 1A-B and 2A-B, panels 15, 150 of cover 100 correspond to first and second portions 61, 63, and enclosure 2 corresponds with gap 400; it may be further seen in FIG. 6B compared with FIGS. 1A-B that fastening elements 18 and 180 may be preformed on portions 61 and 63; elements 18 and 180 may function to hold portions 61 and 63 together during the illustrated manufacturing process as well as to secure heating blanket 1 as previously described in conjunction with FIGS. 1A-B and 2A-B.

FIG. 6C is an end view of the portion of the manufacturing line shown in FIG. 6A, according to an alternate method of the present invention. FIG. 6C illustrates mechanism 52 including first and second pair of heating sealing rollers 525, 527, similar to the embodiment illustrated in FIG. 6B, but further illustrates the line including a cutting tool 529. According to the illustrated embodiment, cutting tool 529 is employed to slit second length of material 60 into first and second portions that would correspond to panels 15 and 150 of FIGS. 1A-B and 2A-B; tool 529 may be disposed between heat sealing rollers 525, 527 to slit simultaneously with sealing, or may be disposed down stream of rollers 525, 527. Cutting tool 529 may include a blade or a laser or any other type of slitting mechanism known to those skilled in the art. Fastening means, for example elements 18, 180 of cover 100, may be preformed on second length of material 60 or formed following the slitting and heat sealing processes. The fastening elements may be any one of a number of types known to those skilled in the art, for example, hook and loop, snap-fit, button, tie strip, and adhesive (low or high tack) types.

FIG. 6D is an end view of a portion of the manufacturing line shown in FIG. 6A, according to yet another method of the present invention. FIG. 6D illustrates mechanism 52 including just first pair of heat sealing rollers 525 and a pair of guide rollers 626. According to the illustrated embodiment, second length of material 60 is bonded to first length 50 at a single site 56, leaving an un-adhered portion designated by a gap 600, and resulting in single-panel covers similar to cover 200 illustrated in FIGS. 3A-B and 4A-B. Referring to FIGS. 3A-B and 4A-B along with FIG. 6D, bonding site 36 of upper sheet 30 to lower sheet 20 corresponds to bonding site 56 and enclosure 3 corresponds to gap 600. Fastening means, for example strip of fastening material 38, may be preformed on second length of material 60 or formed following the heat sealing process.

FIG. 6E is a perspective view of a roll 80 of covers 70 having been formed from first and second lengths of material 50, 60, for example by the process illustrated in FIGS. 6A-B. Referring back to FIG. 6A, after being bonded together, first and second lengths of material 50, 60 pass under a perforating tool 55 that segregates individual covers from one another while still maintaining some continuity between each cover before covers 70 are assembled onto roll 80. According to an alternate embodiment, each length of material 50, 60 are perforated for segregation into a series of lengthwise segments prior to being brought together in the manufacturing line. FIG. 6E illustrates roll 80, having been delivered to a point of use, where individual covers may be dispensed by unrolling and tearing along a perforation line, for example, as illustrated, cover 100 along a perforation line 90. It should be noted that embodiments of the present invention need not include perforations, in which case a cutting step may be incorporated into the cover dispensing process. Furthermore it should be noted that roll 80 about which covers 70 are rolled need not be included in embodiments of the present invention, since covers 70 may be rolled up into a roll without need for an internal support such as roll 80.

Since it is desirable that heating blanket covers be disposable, the embodiments shown in FIGS. 6A-6E provide a cost-effective constructions, manufacturing method and dispensing methods for such covers, such as by using a web-type continuous manufacturing process. A web-type continuous manufacturing process can provide continuous rolls of product with perforations between the individual covers. Packaging and dispensing is much less expensive when the covers can be bulk packaged and then torn off like a towel from a roll of paper towels.

In the foregoing detailed description, the invention has been described with reference to specific embodiments. However, it may be appreciated that various modifications and changes can be made without departing from the scope of the invention as set forth in the appended claims. Furthermore, although embodiments of the invention are described in the context of a hospital, particularly in an operating room, it is contemplated that the invention may be used in other environments.

1. A cover for a heating blanket, the cover comprising:
a flexible lower sheet including a first layer and a second layer, the second layer laminated to the first layer;
a flexible upper sheet; and
a bond between the first and second sheets along a bonding site extending longitudinally along the sheets, the bonding site having been formed by heat sealing together the upper sheet to the second layer of the lower sheet, the upper sheet extending laterally from the bonding site over the lower sheet to a first free edge, the bond creating one edge of an enclosure for holding the heating blanket between the upper and lower sheets, the enclosure being accessible by lifting the first free edge of the upper sheet away from the lower sheet.

2. The cover of claim 1, wherein:
the first layer of the lower sheet comprises polypropylene;
the second layer of the lower sheet comprises a polymeric material selected from the group consisting of low density polyethylene and polyolefin; and
the upper sheet comprises a polymeric material selected from the group consisting of a low density polyethylene and a low density polyethylene/ethylvinylacetate blend.

3. The cover of claim 1, wherein the first layer of the lower sheet, the second layer of the lower sheet, and the upper sheet each comprises a polymer.

4. The cover of claim 1, wherein:
the first layer of lower sheet comprises a cellulose material; and
the second layer of the lower sheet and the upper sheet each comprise a polymer material.

5. The cover of claim 1, wherein the first layer comprises a fibrous material and the second layer comprises a polymer material, the fibrous material having a melting point higher than that of the polymer material.

6. The cover of claim 1, wherein:
the upper sheet includes a first layer and a second layer laminated to the first layer of the upper sheet;
the second layer of the upper sheet faces the second layer of the lower sheet; and
the bonding site is formed between the second layer of the upper sheet and the second layer of the lower sheet.

7. The cover of claim 1, wherein the first layer comprises a fibrous material and the second layer comprises a polymer material, at least one of the upper and lower sheets extends laterally beyond the enclosure over a length greater than approximately one foot.

8. The cover of claim 1, further comprising a fastening element coupled to the upper sheet in proximity to the first free edge of the upper sheet to reversibly secure the upper sheet over the heating blanket within the enclosure.

9. The cover of claim 1, wherein:
the upper sheet is further bonded to the lower sheet along another longitudinally extending bonding site, the other bonding site having been formed by heat sealing together the upper sheet to the second layer of the lower sheet;
the second sheet includes a first portion extending laterally from the bonding site to the first free edge, and a second portion extending laterally, toward the first portion, from the other bonding site to a second free edge of the sheet; and
the enclosure further includes a second edge defined by the other bonding site.

10. The cover of claim 9, wherein at least one of the upper and lower sheets extends laterally beyond the enclosure from the first edge of the enclosure and at least one of the upper and lower sheets extends laterally beyond the enclosure from the second edge of the enclosure.

11. The cover of claim 9, wherein the second portion of the upper sheet overlaps the first portion of the upper sheet.

12. The cover of claim 10, further comprising a fastening element coupled to the upper sheet in proximity to the first free edge of the upper sheet to reversibly secure the upper sheet over the heating blanket within the enclosure.

13. A method of manufacturing a cover for a heating blanket, the method comprising:
laminating a first material layer with a second material layer to form a first sheet; and
coupling a second sheet to the first sheet by heat sealing a first portion the second sheet, along a longitudinally extending bonding site, to the second material layer of the first sheet, while leaving a gap between a second portion of the second sheet and the first sheet;
the second portion of the second sheet extending laterally over the first sheet from the bonding site to a free edge of the second sheet; and
the gap forming an enclosure to hold the heating blanket, the enclosure including a first edge defined by the bonding site and being accessible by lifting the free edge of the second sheet away from the first sheet.

14. The method of claim 13, wherein coupling the second sheet to the first sheet further comprises heat sealing a third portion of the second sheet, along another longitudinally extending bonding site being spaced apart from, and approximately parallel with the bonding site of the first portion, such that the second portion is disposed between the first portion and the third portion thereof, and further comprising forming the free edge of the second sheet by cutting through the second portion of the second sheet along a line approximately parallel with the bonding site.

15. The method of claim 13, further comprising:
coupling a third sheet to the first sheet by heat sealing a first portion of the third sheet to the first sheet along another longitudinally extending bonding site being spaced apart from, and approximately parallel with the longitudinally extending bonding site of the first portion of the second sheet, while leaving a gap between a second portion of the third sheet and the first sheet;
the second portion of the third sheet extending laterally over the first sheet from the other bonding site to a free edge of the third sheet such that the second portion of the third sheet overlaps the second portion of the second sheet; and
the gaps between the second portions of the second and third sheets forming an enclosure for the heating blanket, the enclosure further including a second edge defined by the other bonding site of the third sheet and being accessible by lifting the free edges of the second and third sheets away from the first sheet.

16. A method of manufacturing covers for heating blankets, the method comprising:
laminating a first material layer with a second material layer to form a first length of sheet-like material;
bringing a second length of sheet-like material into contact with the second layer of the first length of sheet-like material;
bonding a first portion of the second length of sheet-like material to the second layer of the first length of sheet-like material along a lengthwise bonding site, while leaving a gap between a second portion of the second length and the second layer of the first length, the second portion of the second length extending laterally from the bonding site over the first length; and
segregating lengthwise segments of the first and second lengths, the lengthwise segments including the first portion of the second length bonded to the second layer of the first length and each segment forming an individual cover;
wherein, for each cover, the gap between the second portion of the second length and the second layer of the first length forms an enclosure to hold a heating blanket.

17. The method of claim 16, wherein the bonding comprises heat sealing.

18. The method of claim 17, wherein the bonding is preformed by pulling the first and second lengths of material between a pair of heat sealing rollers.

19. The method of claim 16, wherein the second portion of the second length extends laterally to a free edge of the second length, the enclosure being accessible by lifting the free edge away from the first length of material.

20. The method of claim 16, further comprising:
bonding a third portion of the second length of sheet-like material to the second layer of the first length of sheet-like material along another length-wise bonding site being spaced apart from, an approximately parallel with the bonding site of the first portion, such that the second portion of the second length is disposed between the first portion and the third portion thereof, and
forming a free edge of the second length of material by cutting through the second portion along a line approximately parallel with the bonding site, the enclosure being accessible by lifting the free edge away from the first length of material.

21. The method of claim 16, further comprising:
bringing third length of sheet-like material into contact with the second layer of the first length of sheet-like material; and
bonding a first portion of the third length of sheet-like material to the second layer of the first length of sheet-like material along another lengthwise bonding site, while leaving a gap between a second portion of the third length and the second layer of the first length, the other bonding site being spaced apart from and approximately parallel with the bonding site of the second length, and the second portion of the third length extending laterally, toward the bonding site of the second length, to a free edge of the third length;
wherein the second portion of the second length extends laterally to a free edge of the second length;
the segregating further includes the third length of material, such that the lengthwise segments forming individual covers further include the first portion of the third length bonded to the second layer of the first length; and
the enclosure of each cover is further formed by the gap between the second portion of the third length and the second layer of the first length, the enclosure being accessible by lifting the free edges of the second and third lengths of material away from the first length of material.

22. The method of claim 21, wherein the second portion of the third length overlaps the second portion of the second length.

23. The method of claim 15, further comprising forming a plurality of perforations through the first and second sheets of material to segregate the lengthwise segments.

24. The method of claim 16, further comprising cutting through the first and second sheets between each lengthwise segment to segregate the lengthwise segments.

25. The method of claim 16, further comprising rolling the first and second lengths of sheet-like material into a roll after bonding the second length to the first length.

26. A method for providing covers for heating blankets, the method comprising:
rolling a series of covers into a roll, the series of covers being formed by lengthwise segments of a first length of sheet-like material coupled to corresponding lengthwise segments of a second length of sheet-like material along a lengthwise bonding site between the first length and a first portion of the second length, a second portion of the second length of material extending laterally from the bonding site over the first length of material and being un-adhered to the first length;
mounting the roll for dispensing the covers;
pulling an end of a first cover of the series from the roll; and
separating the first cover from a second cover in the series.

27. The method of claim 26, wherein separating comprises tearing along a perforation formed between the first and second covers.

28. The method of claim 26, wherein separating comprises cutting.
